(19) United States
(12) Patent Application Publication
(10) Pub. No.: US 2020/0098109 A1
(43) Pub. Date: Mar. 26, 2020

(54) IMAGE PROCESSING DEVICE, IMAGE PROCESSING METHOD, AND IMAGE PROCESSING PROGRAM

(71) Applicant: Hitachi, Ltd., Tokyo (JP)

(72) Inventor: Shino TANAKA, Tokyo (JP)

(73) Assignee: Hitachi, Ltd., Tokyo (JP)

(21) Appl. No.: 16/473,635

(22) PCT Filed: Dec. 5, 2017
(86) PCT No.: PCT/JP2017/043693

§ 371 Date: Jun. 26, 2019

(30) Foreign Application Priority Data
Mar. 1, 2017 (JP) 2017-038603

(51) Int. Cl. G06T 7/11; G06T 3/40; G06T 7/136

(52) U.S. Cl. CPC G06T 7/11; G06T 3/40; G06T 2207/30101; G06T 2207/10081; G06T 2207/30008; G06T 7/136

(57) ABSTRACT

Structural information can be accurately drawn even for a secondary image generated by using resampled image data and mask data. There is provided an image processing device including a mask data acquisition unit that acquires mask data obtained by defining a degree of drawing for each pixel of image data, a resampling processing unit that generates resampled image data by performing resampling processing on the image data, a resampled mask data generation unit that calculates an estimated value obtained by estimating pixel values of the resampled image data based on the mask data and pixels included in a predetermined local region of the image data to generate resampled mask data in which a mask value for each pixel of the resampled image data is determined based on the pixel values of the resampled image data and the estimated value, and an image generation unit that generates an image of a drawing target from the resampled image data and the resampled mask data.

### TECHNICAL FIELD

The present invention relates to an image processing device, an image processing method, and an image processing program, in particular, an image processing device, an image processing method, and an image processing program for performing image processing on image data sampled based on a computed tomography (CT) or magnetic resonance (MR) tomographic image.

### BACKGROUND ART

When interpreting CT and MR tomographic images, 3D images generated based on these tomographic images and secondary images generated by various kinds of analysis processing are used. These secondary images, as 3D images, in particular, include various images such as volume rendering images and multi-planer reconstruction (MPR) images. Moreover, as an image created from analysis processing, there are an image that highlights abnormal structures and an image that visualizes numerical values that serve as indexes in image interpretation.

Then, various methods have been proposed for extracting a specific region when generating such secondary images. For example, in Patent Document 1, it is disclosed that an image of a peripheral blood vessel is acquired by generating a smoothed image from an original image of an image including the peripheral blood vessel, generating a reconstructed image of a bone after highlighting an edge from the original image, and subtracting the reconstructed image of the bone from the smoothed image. That is, Patent Document 1 discloses a technique for drawing a contrasted blood vessel which is a fine structure in a 3D image by using image data only, but not drawing a bone having a density value similar to that of the contrasted blood vessel.

Also, as shown in FIG. 7, for a secondary image, a specific region may be extracted by using data for specifying a processing target called mask data as necessary. The mask data is used in pairs with each image data formed of a plurality of tomographic images and has information indicating the degree of drawing of each pixel of the image data. For example, in the processing of creating a 3D image, binary mask data in which the pixels to be processed are 1 and the others are 0 may be used. At this time, it is possible to display only a desired pixel as a 3D image by calculating the transparency, the color, and the like from the pixel values of the pixels having a value of 1. For example, such processing is performed in the case of creating a 3D image in which a blood vessel is drawn from CT images including a cross-sectional image of a human body in which the blood vessel is contrasted as a structure.

In the case of an analysis image in which a numerical value serving as a reading index is given to each pixel, multi-value mask data whose degree and color of drawing are determined based on this numerical value is created and superimposed on original image data.

Such 3D image creation processing or analysis processing could not be executed or the time to display the result is long because the load on the device in use is large. Therefore, the result of processing with resampled image data and the mask data thereof, such as image size reduction, thinning processing, interpolation processing, and the like, is displayed simply, or the processing result of the resampled data is displayed as a preview until the result is displayed in the original size.

### PRIOR ART DOCUMENT

Patent Document
Patent Document 1: JP-A-2009-229794

### DISCLOSURE OF THE INVENTION

### Problems to be Solved by the Invention

However, using a resampled image has the following problems.

For example, in the case of 3D image generation processing, in the case of simply extracting pixels at equal intervals in resampling, in particular, thinning processing, detailed structural information may be lost in the 3D image. In addition, if it is assumed that the average value of neighboring pixels in the image data is a pixel value after resampling, and the logical sum of the neighboring pixels in the binary mask data is a value of the binary mask data after resampling so that a fine structure is drawn in a 3D image, a fine structure is easily drawn, but the surface of a non-target for masking having pixel values similar to that of the fine structure may be drawn. That is, in the 3D image generated from the image after resampling, there is a trade-off between clearly delineating a fine structure to be drawn and not delineating objects not to be drawn. This is a phenomenon often seen when creating a 3D image for drawing a blood vessel from CT images including a cross-sectional image of a human body in which the blood vessel is contrasted and specifically, may occur when drawing a contrasted blood vessel and a bone having pixel values similar to that of the contrasted blood vessel as a non-target for drawing.

The processing of Patent Document 1 described above can also be performed on the resampled image, but in this case, for example, it is not possible to cope with the case where a user desires a 3D image in which a part of bones is not drawn and another bone is drawn. In addition, when performing the processing of Patent Document 1, it is necessary to temporarily hold a plurality of pieces of data of the same size as the image data, and in a case where there is a limit to the amount of usable memory, the load on the device increases.

The present invention has been made in view of the above situation and has an object of accurately drawing structural information even for a secondary image generated by using resampled image data and mask data.

### Means for Solving the Problems

In order to solve the above-mentioned subject, the present invention provides the following means.

An aspect of the present invention provides an image processing device including a mask data acquisition unit that acquires mask data obtained by defining a degree of drawing for each pixel of image data in order to extract a desired drawing target from the image data, a resampling processing unit that generates resampled image data by performing resampling processing on the image data, a resampled mask data generation unit that generates resampled mask data in which the degree of drawing for the resampled image data is determined based on the mask data, and an image generation unit that generates an image of the drawing target by using the resampled image data and the resampled mask data, in which the resampled mask data generation unit includes an estimated value calculation unit that calculates an estimated value obtained by estimating pixel values of the resampled image data based on the mask data and pixels included in a predetermined local region of the image data, and a mask value determination unit that determines a mask value for each pixel of the resampled image data based on the pixel values of the resampled image data and the estimated value.

### Advantageous Effects of Invention

According to the present invention, structural information can be accurately drawn even for a secondary image generated by using resampled image data and mask data.

### BRIEF DESCRIPTION OF DRAWINGS

FIG. 1 is a block diagram showing a schematic configuration of an image processing system including an image processing device according to a first embodiment of the present invention.

FIG. 2 is a flowchart showing a flow of image processing in the image processing device according to the first embodiment of the present invention.

FIG. 3 is a flowchart showing a flow of processing relating to resampled mask data generation by a resampled mask data generation unit of the image processing device according to the first embodiment of the present invention.

FIG. 4 is a reference diagram for describing local regions, estimated values, and mask values leading to the resampled mask data generation in the image processing device according to the first embodiment of the present invention.

FIG. 5 is a flowchart showing a flow of processing relating to resampled mask data generation by a resampled mask data generation unit of an image processing device according to a second embodiment of the present invention.

FIG. 6 is a reference diagram for describing local regions, estimated values, and mask values leading to the resampled mask data generation in the image processing device according to the second embodiment of the present invention.

FIG. 7 is a reference diagram in the case of generating a 3D image relating to a specific object to be drawn from image data and mask data.

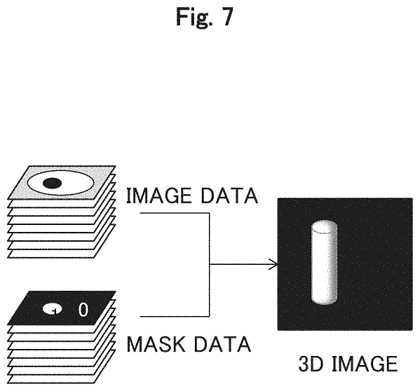

### DESCRIPTION OF EMBODIMENTS

Hereinafter, an image processing device according to an embodiment of the present invention will be described.

The image processing device includes a mask data acquisition unit, a resampling processing unit, a resampled mask data generation unit, and an image generation unit. The mask data acquisition unit acquires mask data obtained by defining a degree of drawing for each pixel in image data in order to extract a desired drawing target from the image data, the resampling processing unit generates resampled image data by resampling the image data, the resampled mask data generation unit generates resampled mask data in which the degree of drawing for the resampled image data is determined based on the mask data, and the image generation unit generates an image of a drawing target with the resampled image data and the resampled mask data. In particular, the resampled mask data generation unit includes an estimated value calculation unit that calculates an estimated value obtained by estimating pixel values of resampled image data based on the mask data and pixels included in a predetermined local region of the image data, and a mask value determination unit that determines a mask value for each pixel of resampled image data based on the pixel values of the resampled image data and the estimated value.

According to such an image processing device, since the mask value is calculated for the pixel of the resampled image data based on the pixel values of the pixels of the resampled image data in which a pixel value is slightly changed and the estimated value for the pixel determined from the local information of the image data, more accurate resampled mask data can be generated for resampled image data. Therefore, it is possible to suppress the drawing of unnecessary pixels and to draw fine structural information without drawing a non-target for drawing.

### First Embodiment

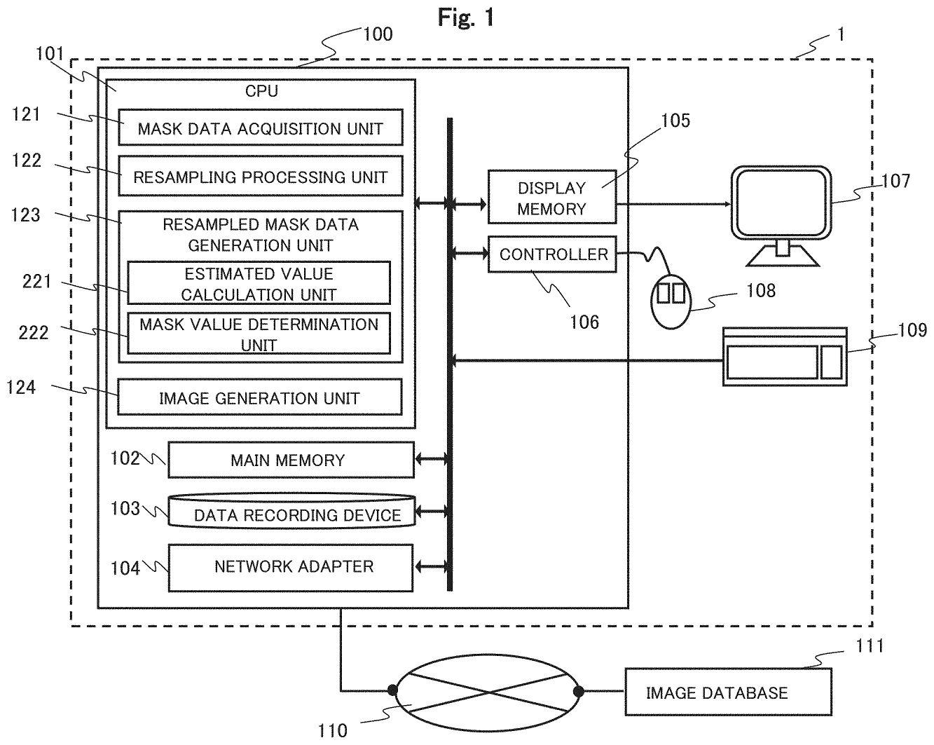

Hereinafter, a medical image processing device according to a first embodiment of the present invention will be described with reference to drawings. FIG. 1 shows the overall configuration of an image processing system including the image processing device of the present invention.

An image processing system 1 includes an image processing device 100, an image display device 107, and a mouse 108 and a keyboard 109 as input devices.

The image processing device 100 includes a central processing unit (CPU) 101 that mainly controls the operation of each component, a main memory 102 in which a control program of the image processing device 100 is stored, a data recording device 103 that stores image data, a display memory 105 that temporarily stores image data of a subject, a network adapter 104 which is a connection interface with an external network 110, and a controller 106 to be connected to the mouse 108. As the data recording device 103, a recording device such as a magnetic disk or a device that writes and reads data to and from a removable external medium can be applied.

The image display device 107 displays an image based on the image data received from the display memory 105. The mouse 108 realizes an input to the image processing device 100 by a user operating a soft switch on the image display device 107. The keyboard 109 includes keys and switches for setting various parameters and realizes a desired input to the image processing device 100 by the user.

The network 110 such as a local region network, a telephone line, or the Internet is connected to the image processing device 100 via a network adapter 104. The image processing device 100 is connected to an external image database 111 via the network adapter 104 and the network 110, and image data can be transmitted between the image processing device 100 and the image database 111. Therefore, in the image processing device 100, for example, image data received from the image database 111 via the network 110 can be stored in the data recording unit 103, and desired image processing can be performed on the image data.

The CPU 101 controls each unit constituting the image processing device 100 and functions as a mask data acquisition unit 121, a resampling processing unit 122, a resampled mask data generation unit 123, and an image generation unit 124.

The mask data acquisition unit 121 generates mask data in which a mask value indicating the degree of drawing for each pixel for the image data is defined in order to extract a desired drawing target from the image data. Alternatively, the mask data acquisition unit 121 acquires mask data by reading mask data set by the user or mask data recorded in the data recording device 13.

The resampling processing unit 122 performs resampling processing on the image data to generate resampled image data. Here, various methods such as thinning processing and interpolation processing can be applied as the resampling processing.

The resampled mask data generation unit 123 generates resampled mask data in which the degree of drawing of the resampled image data is determined, based on the mask data and includes an estimated value calculation unit 221 and a mask value determination unit 222.

The estimated value determination unit 221 calculates an estimated value obtained by estimating pixel values of the resampled image data based on the pixels included in a predetermined local region of the image data. The mask value determination unit 222 determines a mask value for each pixel of the resampled image data based on the pixel value and the estimated value of the resampled image data.

The image generation unit 124 generates an image of a drawing target by using the resampled image data and the resampled mask data. Asa representative example of the image generated by the image generation unit 124, a 3D image or the like relating to a drawing target is mentioned.

The above-described units can be realized as software by the CPU 101 reading and executing a program stored in advance in a storage unit such as the main memory 102 or the data recording unit 103. Some or all of the operations performed by these units may be realized by an application specific integrated circuit (ASIC) or a field-programmable gate array (FPGA).

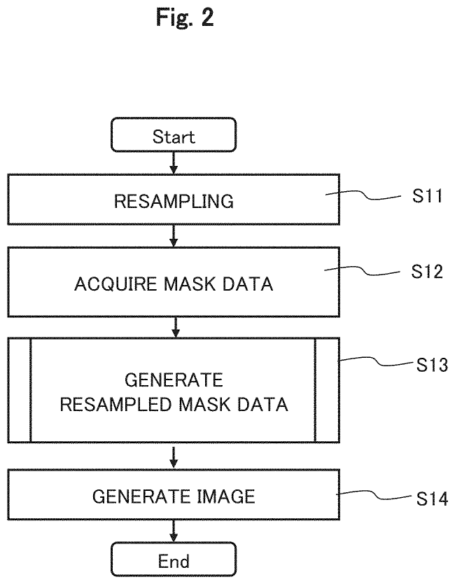

Subsequently, an image processing method in the above-described image processing device 100 will be described according to the flowchart of FIG. 2. In the present embodiment, an example will be described, in which image data formed of a plurality of CT tomographic images including a cross-sectional image of a human body is resampled to create a 3D image from image data having a small data size. In particular, it is assumed that a contrasted blood vessel including a fine structure is drawn, and a bone having similar pixel values is not drawn to generate a 3D image.

In step S11, the resampling processing unit 122 performs resampling processing based on the image data (hereinafter, referred to as “original image data”) relating to the CT tomographic images stored in the data recording device 103 to generate resampled image data. The resampled image data mentioned here is image data in which the structural information of the target remains as much as possible after the resampling processing is performed. Therefore, the resampled image data is hereinafter simply referred to as “structural data”. The data size of the structural data is smaller than the original size.

In the specific processing in step S11, the resampling processing unit 122 first performs convolution processing on the original image data. Examples of the convolution processing here include processing using a moving average filter or a Gaussian filter. Other than this, a median filter may be used, or filter processing may be used to obtain an n-th (n=1, 2, . . . , the number of pixels included in the kernel) pixel value of a pixel in the kernel, and it is preferable to select processing in which the structure to be drawn remains more.

Then, the resampling processing unit 122 obtains structural data as resampled image data by performing resampling processing such as thinning processing on the image data subjected to the convolution processing.

The image data after convolution processing becomes an image that is blurred compared to that before the processing, but the diameter of a fine contrasted blood vessel or the like becomes slightly larger. If thinning processing is performed on image data in this state, a region indicating a contrasted blood vessel is likely to remain on the image data. Therefore, the structural data to be generated is data that holds the structural state although a pixel value is changed.

In the next step S12, the mask data acquisition unit 121 acquires (generates) mask data based on the original image data stored in the data recording device 103. Specifically, image data relating to the CT tomographic images stored in the data recording device 103 is segmented to extract a drawing target and hold the drawing target as binary mask data having a mask value of 1 or 0 indicating a degree of drawing. That is, in the binary mask data, a pixel having a mask value of 0 is a non-target for drawing, and a pixel having a value of 1 is a target for drawing. Segments are extracted by using threshold processing, region growing method, level set method, or the like. Also, the user can manually extract a drawing target.

In step S13, the resampled mask data generation unit 123 calculates an estimated value of the pixel value for each pixel of the original image data from the local information of the mask data generated in step S12 to generate resampled mask data indicating the degree of drawing of the drawing target in the structural data based on the estimated value. Details of the processing relating to resampled mask data generation will be described later.

In step S14, image processing is performed by using the structural data and the resampled mask data to generate a 3D image.

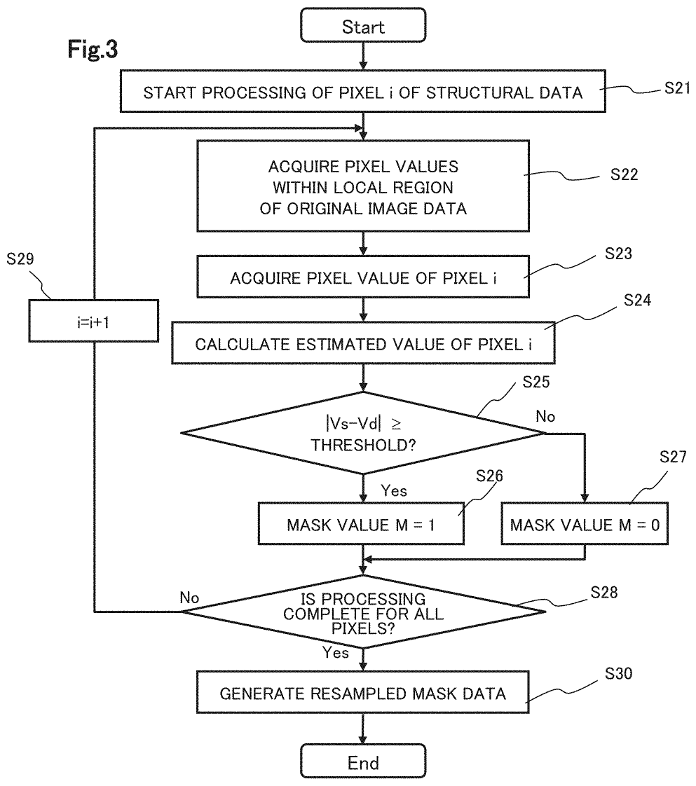

Subsequently, processing relating to resampled mask data generation by the resampled mask data generation unit 123 will be described according to the flowchart of FIG. 3.

In step S21, generation processing of resampled mask data to be applied to the structural data generated by the resampling processing is started. That is, mask value determination processing for a pixel i (i=1, 2, 3, . . . n) in the structural data is started.

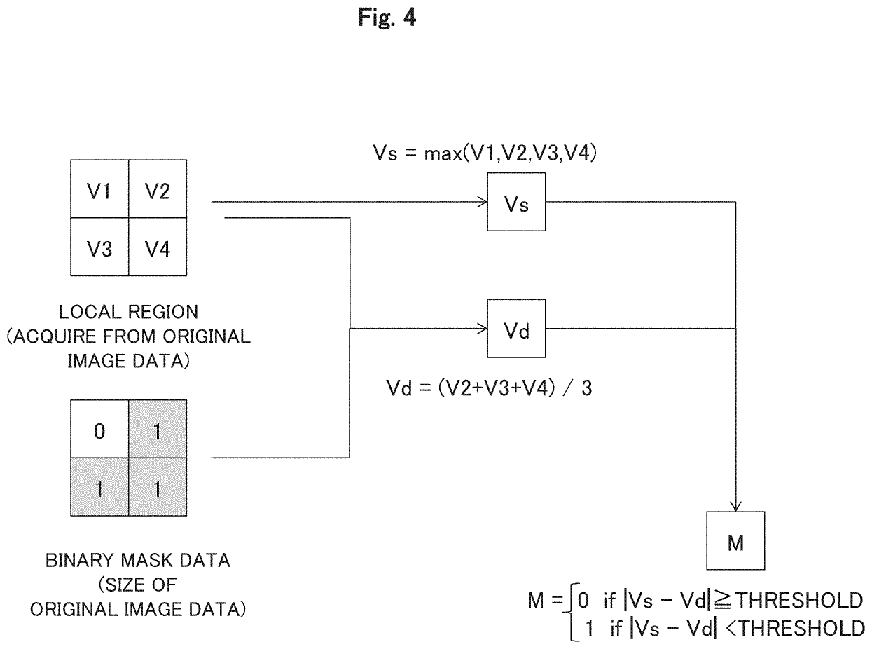

In step S22, in the original image data, the pixel values of the pixels in the local region including the pixel at the position corresponding to the pixel i of the structural data and the pixels in the vicinity of the pixel are acquired. As shown in FIG. 4, in the present embodiment, for convenience of description, the local region of the original image data is a region formed of a total of 4 pixels having 2 pixels×2 pixels. The standard of the number of pixels included in the local region can be a number of approximately “number of images before resampling/number of pixels after resampling”.

In step S23, a pixel value Vs of the structural data is acquired. In other words, the local region is a region including the pixel of the original image data at the position corresponding to the pixel i of the structural data and the pixels in the vicinity of the pixel, and the pixel value Vs of the structural data is acquired by acquiring the pixel value Vs of the pixel i of the structural data from among the pixel values of the pixels included in the local region. In the present embodiment, as shown in FIG. 4, as the pixel value Vs of the structural data, a maximum pixel value is selected from values V1, V2, V3, and V4 of the pixels in the local region and set as Vs as an example. Since the present embodiment is characterized in that the pixel value of the blood vessel is large, the structure of the target blood vessel is likely to remain more in the structural data by acquiring the large pixel value. In a case where the pixel value of the structure to be drawn is small, the processing is appropriately changed by, for example, taking a minimum value.

In step S24, the estimated value calculation unit 221 acquires an estimated pixel value Vd obtained by estimating the pixel values of the structural data from the pixels included in the local region. The estimated pixel value Vd indicates a value estimated obtained by taking the pixel values of the pixels (mask value=1) to be drawn in the image to be generated.

In the present embodiment, as shown in FIG. 4, the mask values of the pixels in the binary mask data corresponding to the pixels V1, V2, V3, and V4 included in the local region are set to 0, 1, 1, 1, respectively. Since the pixels of which the value of the binary mask data is 1 are the 3D image creation target, the estimated value calculation unit 221 calculates the average value Vd=(V2+V3+V4)/3 of the pixel values V2, V3, and V4 of the image data in which the value of the binary mask data is 1 as the estimated value Vd of the pixel of the structural data corresponding to the pixel i.

Here, an example is given in which an average value is used as an estimated value, but the method of determining the estimated value Vd can be appropriately changed according to the drawing target as an image, and the estimated value Vd may be the maximum value, the minimum value, or the median value of the pixels in the local region, or the probability that the value of the binary mask for the pixel value from the local region is 1 may be calculated and the pixel value with the highest probability may be used as an estimated value.

In step S25, the mask value determination unit 222 compares the absolute value of the difference between the estimated value Vd of the pixel i of structural data corresponding to the pixels of the local region of the original image data calculated in step S24 and the pixel value Vs of the structural data acquired from the local region of the original image data in step S23 with a predetermined threshold. As a result of comparison between the absolute value and the predetermined threshold by the mask value determination unit, in a case where the absolute value is greater than or equal to the threshold, the flow proceeds to step S26, and it is determined that the pixel is a drawing target pixel and a mask value M for the pixel i is set to 0. As a result of comparison between the absolute value and the predetermined threshold by the mask value determination unit, in a case where the absolute value is less than the threshold, the flow proceeds to step S27, and it is determined that the pixel is not a drawing target pixel and the mask value M for the pixel i is set to 1.

In the next step S28, it is determined whether the above processing has been performed for all the pixels of the structural data, and in a case where the processing is not complete for all the pixels, the flow proceeds to step S29, and the next processing target pixel is determined and the processing from step S22 to step S28 is repeated. In a case where processing is complete for all pixels, the flow proceeds to step S30, and all mask values M for respective pixels calculated are stored in the data recording device 103 as resampled mask data, and the above processing is ended. The generated resampled mask data is used in the generation of a 3D image in step S14 of FIG. 2.

The above processing is described by being applied to a specific example. For example, in order to create a 3D image in which a desired contrasted blood vessel is drawn, binary mask data is generated in which the value of the bone portion is set to 0 and pixels other than bone including the contrasted blood vessel and soft tissue are set to 1. At this time, the surface of the bone is a boundary surface between the region of the bone whose binary mask data is 0 and the region of the soft tissue whose binary mask data is 1. When the above processing is performed at such a boundary surface, since the pixel having the binary mask data of 1 is a pixel of the soft tissue having a pixel value smaller than that of the bone, the estimated value Vd is about the pixel value equivalent to the soft tissue.

Here, in a case where the pixel value Vs of the structural data in the pixel i becomes equivalent to the bone, the difference with the estimated value Vd becomes large, and therefore the mask value M becomes zero. On the other hand, in a case where the pixel value Vs of the structural data in the pixel i becomes about the pixel value of the soft tissue, the difference with the estimated value Vd becomes small, and the mask value becomes 1. Finally, when creating a 3D image from structural data and resampled mask data, as a result of calculating the structural data, a pixel having a pixel value equivalent to the bone near the boundary of the bone is set to 0 in the target data, and therefore the pixel is not a target of the 3D image creation processing and is not drawn. That is, a desired contrasted blood vessel can be drawn without drawing the surface of the bone. This can also be applied to the case where the value of binary mask data is set to 0 for only some bones.

Also, in the case of applying binary mask data in which the pixels of the contrasted blood vessel are 1 and the other pixels are 0, the estimated value Vd is equivalent to the contrasted blood vessel in the vicinity of the surface of the blood vessel, and the structural data having a value close to the contrasted blood vessel has a value of 1 in the target data, and the value of the target data of the pixel having a large difference is 0.

As described above, according to the present embodiment, it is possible to generate optimal resampled mask data. That is, according to the present embodiment, a more accurate mask value can be calculated for the pixel value Vs after thinning by comparing with the pixel of the estimated value Vd obtained from the local information for each pixel of the structural data in which a pixel value is slightly changed.

That is, since it is possible to generate more accurate resampled mask data for resampled image data, it is possible to suppress unnecessary pixels from being drawn and to draw fine structural information without drawing a non-target for drawing. Furthermore, highly accurate resampled mask data can be obtained for arbitrary mask data set by the user. In addition, it is not necessary to prepare a plurality of pieces of data having the same size as the image data for the amount of memory to be used, and the load on the device can be suppressed.

In the present embodiment, as an example, a 3D image with a contrasted blood vessel as a drawing target and a bone as a non-target for drawing has been described, but the present invention can also be applied to other regions such as creating a 3D image with a contrasted blood vessel as a drawing target and a contrasted residue and a bone as a non-target for drawing in an image containing the contrasted blood vessel and the contrasted residue obtained on colon CT.

### Second Embodiment

Next, an image processing device according to a second embodiment of the present invention will be described. In the first embodiment described above, an example of resampled image data formed of a plurality of CT tomographic images including a cross-sectional image of a human body to create a 3D image from image data having a small data size, in particular, an example of creating a 3D image in which a desired contrasted blood vessel is drawn has been described. In the present embodiment, processing of cutting out and enlarging a part of an image and attaching the image to another image having a smaller pixel size will be described. Such processing is, for example, processing of cutting out a tumor part from a PET image, and enlarging and superimposing the tumor part on another image such as a CT image or an MR image having a small pixel size (or FOV) so that the pixel size becomes the same. The image processing device according to the present embodiment has the same configuration as the image processing device according to the first embodiment described above, and therefore the same reference numerals are given and detailed description of each configuration is omitted, and only the flow of generation processing of resampled mask data will be described.

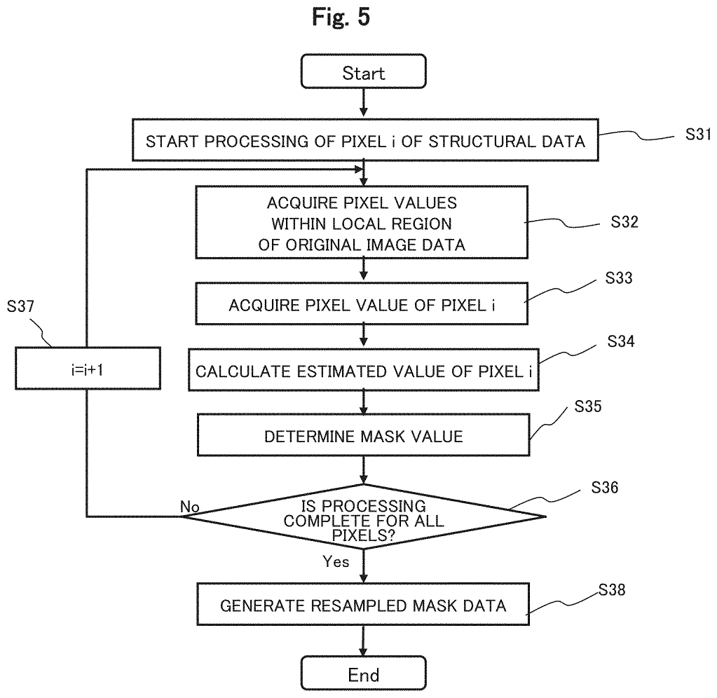

Hereinafter, processing of generating resampled mask data in the image processing device according to the present embodiment will be specifically described with reference to the flowchart of FIG. 5. In the image processing device, prior to generation of the resampled master data, the mask data acquisition unit 121 acquires mask data of the original image data, and the resampling processing unit 122 performs convolution processing and generates structural data in which a tumor is highlighted as resampled image data by performing resampling processing such as enlargement processing on the image data subjected to the convolution processing. In the present embodiment, the mask data is binary mask data, and the structural data is an enlarged image larger in size than the original image data.

In step S31, generation processing of resampled mask data to be applied to the enlarged image as structural data generated by the resampling processing is started. That is, mask value determination processing for a pixel i (i=1, 2, 3, . . . n) in the structural data is started.

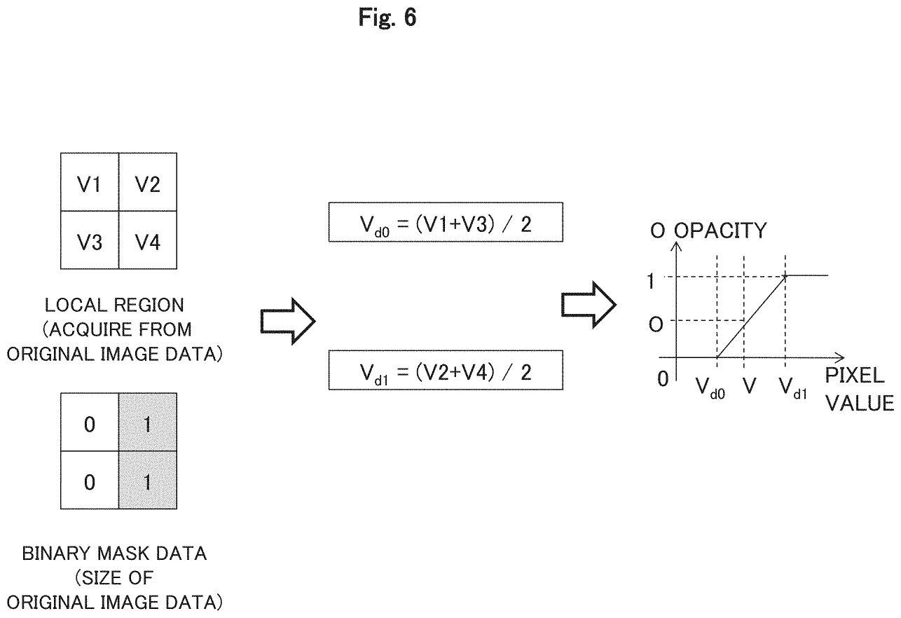

In step S32, the resampled mask data generation unit 123 selects a pixel group of the original image data used in the interpolation processing in order to obtain the pixel value of the pixel i of the enlarged image which is structural data, as a local region. FIG. 6 shows, as an example, a local region formed of a total of four pixels having 2 pixels×2 pixels assuming two-dimensional linear interpolation.

In step S33, a pixel value V of the structural data is acquired. The pixel value V of the pixel i of the structural data is a value obtained by performing interpolation processing on a local region of the original image data.

In step S34, the estimated value calculation unit 221 uses, for the local region, the mask values in the mask data corresponding to the local region to obtain an average pixel value V_{d0} of pixels of which the mask value=0 as a first estimated value among the pixels in the local region. As shown in FIG. 6, among the pixels in the local region, pixels V1 and V3 have mask values of 0, and therefore the average value V_{d0} of the pixel values of the pixels V1 and V3 is calculated as a second estimated value.

Similarly, the estimated value calculation unit 221 acquires an average pixel value V_{d1} of the pixels of which the mask value=0 in the local region, as a second estimated value. As shown in FIG. 6, among the pixels in the local region, pixels V2 and V4 have mask values of 1, and therefore the average pixel value V_{d1} of the pixel values of the pixels V2 and V4 is calculated as a second estimated value. Therefore, it is assumed that the more accurate pixel value of the pixel value V of the structural data is between V_{d0} and V_{d1}.

In step S35, the mask value determination unit 222 obtains a mask value indicating an opacity O by using the pixel value V and the estimated values V_{d0} and V_{d1}. When V_{d0}<V_{d1}, the relationship between the pixel values and the opacity O shown in the graph of FIG. 6 is assumed, and the opacity O is calculated from this relationship. Specifically, the opacity can be defined according to the following equation (1).

$$\begin{matrix}[ Equation 1 ] & \\ O = \{ \begin{matrix}0 & if V \leq {V}_{d 0} \\ \frac{V - {V}_{do}}{{V}_{d 1} - {V}_{d 0}} & if {V}_{d 0} < V < {V}_{d 1} \\ 1 & if V \geq {V}_{d 1}\end{matrix} & ( 1 )\end{matrix}$$

In the next step S36, it is determined whether the above processing has been performed for all the pixels of the structural data, and in a case where the processing is not complete for all the pixels, the flow proceeds to step S32, and the next processing target pixel is determined and the processing from step S32 to step S36 is repeated. In a case where processing is complete for all pixels, the flow proceeds to step S38, and all mask values M for respective pixels calculated are stored in the data recording device 103 as resampled mask data, and the above processing is ended.

The generated resampled mask data is used in the generation of a 3D image in step 14 of FIG. 2. That is, the resampled mask data is used when superimposing the enlarged image on one image. Assuming that the value of the structural data is V, the value of the sampled mask data, that is, the mask value is O, and the pixel value of another image serving as the background is P_{back}, a pixel value P of the final result is as shown in the following equation (2).

[Equation 2]

P=(1−O)*P_{back}+O*V (2)

Thus, according to the image processing device according to the present embodiment, unnecessary protrusion is alleviated at the boundary of the tumor part in the enlarged image, and the shape of the structure is easily visible by determining a mask value according to the estimated value obtained from the original image data and the mask data for the original image data and applying the mask value to structural data. In addition, it is possible to check the shape of the background image and to facilitate shape evaluation by making the boundary translucent.

### REFERENCE SIGNS LIST

1 image processing system
100 image processing device
101 CPU
102 main memory
103 data recording device
104 network adapter
105 display memory
106 controller
107 display device
108 mouse
109 keyboard
110 network
111 image database
121 mask data acquisition unit
122 resampling processing unit
123 resampled mask data generation unit
124 image generation unit
221 estimated value calculation unit
222 mask value determination unit

1. An image processing device comprising:
a mask data acquisition unit that acquires mask data obtained by defining a mask value indicating a degree of drawing for each pixel of image data in order to extract a desired drawing target from the image data;
a resampling processing unit that generates resampled image data by performing resampling processing on the image data;
a resampled mask data generation unit that generates resampled mask data formed of mask values of respective pixels, obtained by defining a degree of drawing of the resampled image data, based on the mask data; and
an image generation unit that generates an image of the drawing target by using the resampled image data and the resampled mask data,
wherein the resampled mask data generation unit includes
an estimated value calculation unit that calculates an estimated value obtained by estimating pixel values of the resampled image data based on the mask data and pixels included in a predetermined local region of the image data, and
a mask value determination unit that determines a mask value for each pixel of the resampled image data based on the pixel values of the resampled image data and the estimated value.

2. The image processing device according to claim 1,
wherein the mask data is binary mask data having a mask value of 1 or 0.

3. The image processing device according to claim 2,
wherein the estimated value calculation unit sets an average value of pixel values of the pixels of which the mask value of the binary mask data is 1 among the pixels in the local region, as the estimated value.

4. The image processing device according to claim 1,
wherein the resampling processing unit performs image compression processing or image enlargement processing as the resampling processing to generate resampled image data.

5. An image processing method comprising:
acquiring mask data obtained by defining a mask value indicating a degree of drawing for each pixel of image data in order to extract a desired drawing target from the image data;
generating resampled image data by performing resampling processing on the image data;
calculating an estimated value obtained by estimating pixel values of the resampled image data based on the mask data and pixels included in a predetermined local region of the image data to generate resampled mask data obtained by defining a mask value of each pixel of the resampled image data based on the pixel values of the resampled image data and the estimated value; and
generating an image of the drawing target by using the resampled image data and the resampled mask data.

6. An image processing program for causing a computer to execute an image process, the process comprising:
acquiring mask data obtained by defining a mask value indicating a degree of drawing for each pixel of image data in order to extract a desired drawing target from the image data;
generating resampled image data by performing resampling processing on the image data;
calculating an estimated value obtained by estimating pixel values of the resampled image data based on the mask data and pixels included in a predetermined local region of the image data to generate resampled mask data obtained by defining a mask value of each pixel of the resampled image data based on the pixel values of the resampled image data and the estimated value; and
generating an image of the drawing target by using the resampled image data and the resampled mask data.
